(19) United States
(12) Patent Application Publication
(10) Pub. No.: US 2008/0202602 A1
(43) Pub. Date: Aug. 28, 2008

(54) Valve Controlled Vacuum Assembly

(75) Inventors: Richard A. Flaim, New Boston, MI (US); Troy Foster, Troy, MI (US)

Correspondence Address: CLARK HILL, P.C., 500 WOODWARD AVENUE, SUITE 3500, DETROIT, MI, 48226, US

(73) Assignee: PIAB USA, INC., Hingham, MA (US)

(21) Appl. No.: 11/677,709

(22) Filed: Feb. 22, 2007

(51) Int. Cl. F16K 31/12

(52) U.S. Cl. 137/488

(57) ABSTRACT

A valve assembly controls a vacuum. The valve assembly includes a poppet valve operatively connected to the vacuum. The poppet valve is movable between an open state and a closed state to turn the vacuum on and off respectively. A pilot valve is fixedly secured to the poppet valve to selectively move the poppet valve between its open and closed states. The valve assembly also includes a bladder system for controlling the pilot valve such that the pilot valve moves the poppet valve to the open position only when the bladder system measures a reduced suction force created by the vacuum to force the vacuum to increase the suction force produced thereby.

### BACKGROUND ART

1. Field of the Invention

The invention relates generally to a vacuum assembly. More particularly, the invention relates to a valve controlled vacuum assembly that reduces the consumption of energy in the operation thereto.

2. Description of the Related Art

Vacuums are useful devices in the manufacturing of items. Vacuums can be used to create a suction force that can be used to grab hold of a generally flat surface without damaging it. When a suction cup is used in conjunction with a vacuum, the suction cup can be secured to a desired part or item and moved or positioned more easily Oftentimes, the suction cups are affixed to the ends of robot arms to facilitate the robot and its ability to grab a hold of an item.

In many situations, it is desirable to have the vacuum generating device as close to the suction cup as possible. In these situations, compressed air is used by the vacuum generating device to create the vacuum. One disadvantage of many of the system out there is the requirement for a constant source of compressed air for as long as the vacuum is need for the suction force. Use of the energy to supply the constant source of compressed air is costly. Therefore there is a desire for vacuum without the need for a constant source of compressed air.

### SUMMARY OF THE INVENTION

A valve assembly controls a compressed air operated vacuum circuit. The valve assembly includes a poppet valve operatively connected to the vacuum circuit. The poppet valve is movable between an open state and a closed state to turn the vacuum circuit on and off, respectively. A pilot valve is fixedly secured to the poppet valve to selectively move the poppet valve between its open and closed states. The valve assembly also includes a bladder system for controlling the pilot valve such that the pilot valve moves the poppet valve to the open position only when the bladder system measures a reduced suction force created by the vacuum to force the vacuum to increase the suction force produced thereby.

Advantages of the invention will be readily appreciated as the same becomes better understood by reference to the following detailed description when considered in connection with the accompanying drawings, wherein:

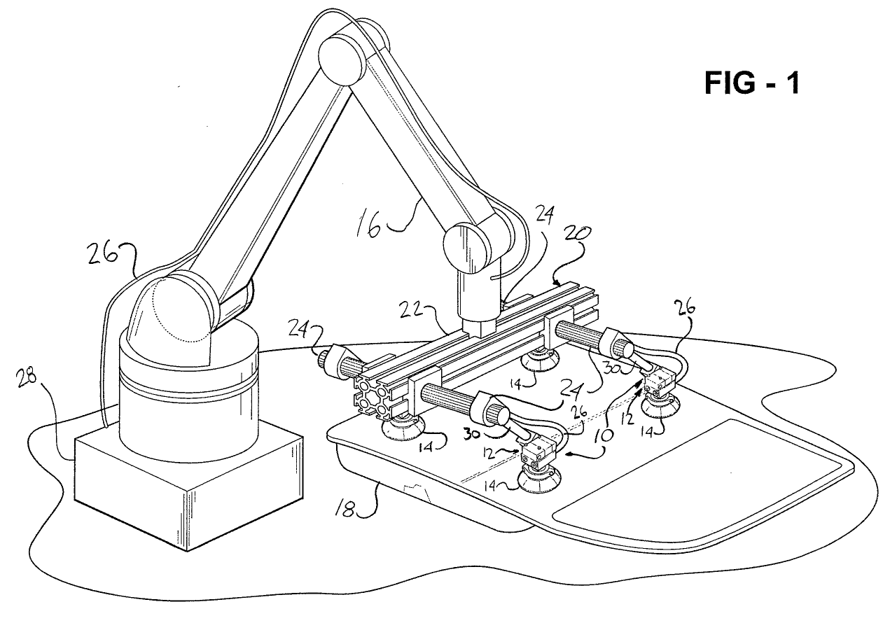

FIG. 1 is a perspective view of one embodiment of the invention;

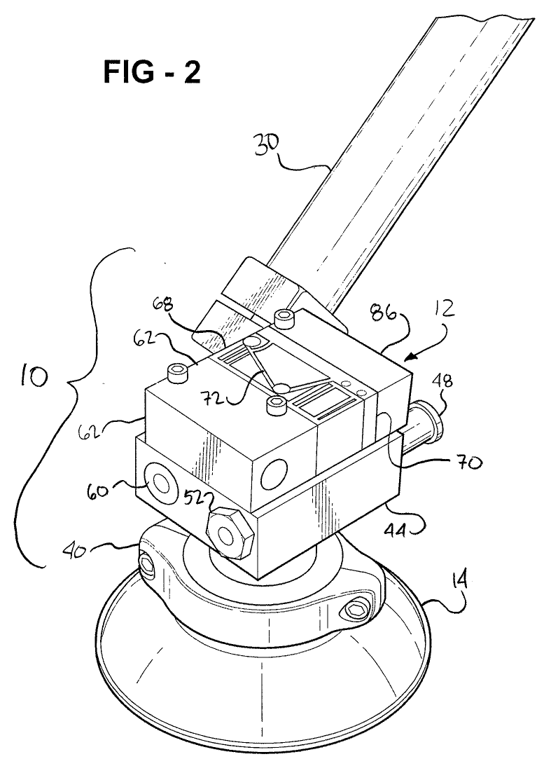

FIG. 2 is a top view of the invention; and

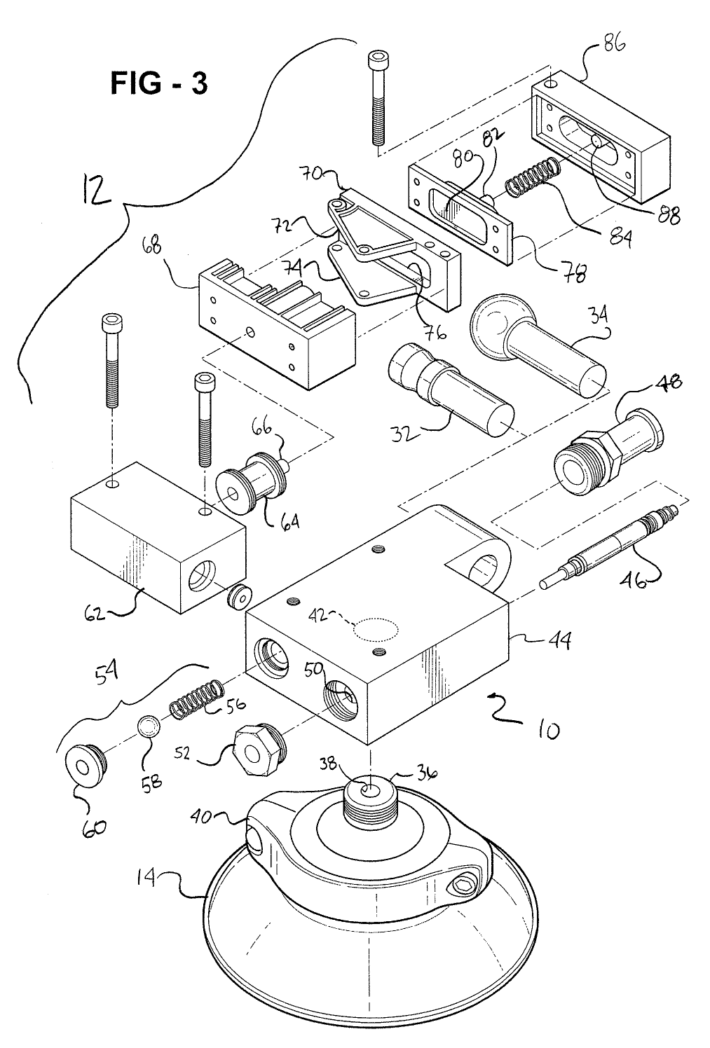

FIG. 3 is an exploded perspective view of the invention.

### DETAILED DESCRIPTION OF THE PREFERRED EMBODIMENTS

Referring to FIG. 1, a valve assembly according to the invention is generally indicated at 10, The valve assembly 10 is used to control a vacuum circuit, generally indicated at 12. In one embodiment, the invention is a valve controlled vacuum assembly.

The valve assembly 10 is used to create a vacuum, which in turn, operates a suction cup 14. There are four suction cups 14 shown in FIG. 1. The suction cups 14 are secured to the valve assembly 10. The valve assemblies 10 are secured to a robot arm 16 which is used for methods relating to manufacturing, packaging, and the like. In the embodiment shown in FIG. 1, the robot arm 16 is used in the process of manufacturing a door 18 of a motor vehicle not shown, It should be appreciated by those skilled in the art that the valve assembly 10 and the robot and 16 may be used in conjunction with the suction cup 14 to operate, lift, orient and/or move any type of item from an automotive door, as shown in FIG. 1 at 18, to something as small and fragile as an egg to be packaged in a carton for distribution and retail sale.

A positioning mechanism generally indicated at 20, is used to position the suction cups 14 with respect to the door 18 to be manipulated by the robot arm 16. The positioning mechanism 20 may take any configuration necessary to allow the robot arm 16 the ability to adequately lift and manipulate the door 18. In the embodiment shown, the positioning mechanism 20 includes a backbone structure 22 with a plurality of legs 24 extending out therefrom. A pneumatic line 26 runs along the robot arm 16 and through each of the legs 24 to provide compressed air to the valve assembly 10. The valve assembly 10 and the vacuum circuit 12 operate on compressed air to operate the vacuum circuit 12 in such a manner to operate the suction cups 14. The source of the compressed air is not shown and may be located remote from the robot arm 16. The robot arm 16 is secured to a base 28 which may be fixed in position or may be movable as is required to perform the function for which the robot arm 16 is designed.

Referring to FIGS. 2 and 3, the valve assembly 10 is shown in greater detail. The valve assembly 10 is secured to the robot arm 16 through an extension arm 30. The extension arm 30 may secure the position and/or orientation of the suction cup 14 with respect to the robot arm 16. The valve assembly 10 is secured to the extension arm using any number of mounts. Referring specifically to FIG. 3, an apple-core mounting pin 32 and a ball joint mounting pin 34 are shown as alternatives that may be used to secure the valve assembly 10 to the extension arm 30. The choice of mounting pin would be dictated by the requirements of the valve assembly 10 and/or the suction cup 14. It should be appreciated by those skilled in the art that other types of mounting pins may be utilized to facilitate the operation of the valve assembly.

The suction cull 14 includes a threaded mounting m ember 36 that defines a pressure channel 38 coaxial with the threaded mounting member 36. When a vacuum is drawn, discussed in greater detail subsequently, a vacuum is pulled through the pressure channel 38 allowing the suction cup 14 to create suction with the part, the door 18 in FIG. 1, to be affixed thereto. A suction cup collar 40 secures the suction cup 14 to the threaded mounting member 36.

The threaded Mounting member 36 threadingly engages a vacuum opening. 42 (shown in phantom) of a vacuum body 44. The vacuum body 44 houses a vacuum generator 46. The vacuum generator 46 is a compressed air operated vacuum generator 46 and is controlled by the compressed air extending through the pneumatic line 26. In the embodiment shown, the compressed air operated vacuum generator is a coaxial cartridge that is held in the vacuum body 44 via a cartridge holder 48 that threadingly engages a vacuum channel 50 in the compressed air operated vacuum generator 46 is housed. A plug 52 seals the vacuum channel 48 at an end opposite the cartridge bolder 48. Therefore, the cartridge holder 48, compressed air operated vacuum generator 46 and the plug 52 are coaxial.

The vacuum body also includes a blow off side that is regulated by a blow off valve 54 that includes a blow off spring 56, a ball 58 disposed at the end of blow off spring 56 and a blow off plug 60 that maintains the ball 58 and blow off spring 56 in position. The blow off valve 54 operates with respect to the vacuum generator 46 in a known manner.

Disposed adjacent the vacuum body 44 is a valve body 62. The valve body 62 houses a poppet valve 64 therein. The poppet valve 64 includes a poppet valve trigger 66 The poppet valve trigger 66 extends into a pilot valve 68. A pilot top mount 70 covers the pilot valve 68. The pilot top mount 70 includes two side flanges 72, 74 that extend over the sides of the pilot valve 68. The pilot top mount 70 has a pilot opening 76 disposed through the pilot top mount 70. A diaphragm frame 78 is fixedly secured to the pilot top mount 70. The diaphragm frame 78 includes a flexible diaphragm 80 that is in fluid communication with the pilot valve 68 because the majority of the flexible diaphragm 80 extends over the pilot opening 76 in the pilot top mount 70.

The flexible diaphragm 80 includes a diaphragm pin 82 molded thereto. The diaphragm pin 82 is used to position a hysteresis spring 84. The hysteresis spring 84 is received by a valve cover 86. The valve cover 86 includes a cover pin 88 which keeps the other end of the hysteresis spring 84 in position. The valve cover 86 is mounted to the diaphragm frame 78 and the pilot top mount 70.

In operation, compressed air flows through the pneumatic line 26 and enters the vacuum channel 50 of the vacuum body 44. The flowing air passed the compressed air operated vacuum generator 46 creates a vacuum which, in turn, provides the force necessary for the suction cup 14 to create suction against a part, such as the door 18 shown in FIG. 1. Once the suction cup 14 obtains the proper suction force, the compressed air is turned off.

As the suction cup 14 loses its suction, the hysteresis spring 84 forces the flexible diaphragm 80 downwardly into the pilot valve 68. Once the pilot valve 68 moves a predetermined amount, it triggers the poppet valve 64 to open. Once the poppet valve 64 is open, the compressed air in the pneumatic line 26 is reopened and compressed air flows over the compressed air operated vacuum generator 46 to draw a vacuum and re-establish the suction force of the suction cup 14.

The poppet valve 64, the pilot valve 68 aid the hysteresis spring 84 are all designed to allow the suction cup 14 to vary in suction force between 25 standard cubic feet per minute (SCFM) to 17 SCFFM.

Without the invention, a continuous supply of compressed air must flow over the compressed air operated vacuum generator 46 to maintain the suction force created by the suction cup 14. When it is determined that the suction cup 14 is to release the object 18 being held thereby, the compressed air is turned off allowing the vacuum to be exhausted land allowing thee suction cup 14 to release its suction force.

With the valve assembly 10, however, the suction cup 14 may maintain its suction force without having continuous compressed air flow through the pneumatic line 26. As such, the consumption of compressed air is reduced to less than two percent of that which is manually required by a suction cup 14 when it is lifting an object 18 such as the door as depicted in FIG. 1. Therefore, the savings in energy consumption is great.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

What is claimed:

1. A valve assembly for controlling a compressed air operated vacuum circuit, said valve assembly comprising:
a poppet valve operatively connected to the compressed air operated vacuum generator, said poppet valve movable between an open state and a closed state to turn the vacuum on and off, respectively;
a pilot valve fixedly secured to said poppet valve to selectively move said poppet valve between its open and closed states; and
a bladder system for controlling said pilot valve such that said pilot valve moves said poppet valve to the open position only when said bladder system measures a reduced suction force created by the vacuum to force the vacuum to increase the suction force produced thereby.

2. A valve assembly as set forth in claim 1 wherein said bladder system includes a flexible diaphragm disposed adjacent said pilot valve for moving toward and away from said pilot valve.

3. A valve assembly as set forth in claim 2 wherein said bladder assembly includes a hysteresis spring for applying a force against said flexible diaphragm to control the movement of said flexible diaphragm in response to movement of said pilot valve.

4. A valve assembly as set forth in claim 3 wherein said bladder assembly includes a housing for housing said flexible diaphram and said hysteresis spring therein.

5. A valve controlled vacuum assembly comprising:
a vacuum housing defining an inlet port, a vacuum port and an exhaust port;
a compressed air operated vacuum generating device disposed within said vacuum housing for creating a vacuum;
a poppet valve operatively connected to said vacuum generator, said poppet valve movable between an open state and a closed state to turn said vacuum generator on and off, respectively;
a pilot valve fixedly secured to said poppet valve to selectively move sad poppet valve between its open and closed states; and
a bladder system for controlling said pilot valve such that said pilot valve moves said poppet valve to the open position only when said bladder system measures a reduced vacuum created by said vacuum to force said vacuum generator to increase the vacuum produced thereby.

6. A valve controlled vacuum assembly as set forth in claim 5 wherein said bladder system includes a flexible diaphragm disposed adjacent said pilot valve for moving toward and away from said pilot valve.

7. A valve controlled vacuum assembly as set forth in claim 6 wherein said bladder assembly includes a hysteresis spring for applying a force against said flexible diaphragm to control the movement of said flexible diaphram in response to movement of said pilot valve.

8. A valve controlled vacuum assembly as set forth in claim 7 wherein said bladder assembly includes a housing for housing said flexible diaphragm and said hysteresis spring therein.

9. A valve controlled vacuum assembly as set forth in claim 8 wherein said inlet port receives compressed air to operate said vacuum generator.

10. A valve controlled vacuum assembly as set forth in claim 9 wherein said vacuum is a vacuum cartridge defining a longitudinal axis.

11. A valve controlled vacuum assembly as set forth in claim 10 wherein said vacuum housing includes a blow off mechanism.

12. A valve controlled vacuum assembly as set forth in claim 11 wherein said blow off mechanism includes a blow off spring.

13. A valve controlled vacuum assembly as set forth in claim 12 wherein said blow off mechanism further includes a ball or a poppet disposed adjacent said spring for sealing said exhaust port against back pressure.

14. A valve controlled vacuum assembly as set fourth in claim 13 wherein said flexible bladder includes a spring receiving hub for receiving and positioning said hysteresis spring against said flexible bladder.

15. A valve controlled vacuum assembly as set forth in claim 14 including a holder removably securable to said vacuum housing, said holder secures said vacuum device in said vacuum housing.

16. A valve controlled vacuum assembly as set forth in claim 15 wherein said vacuum device is a vacuum ejector assembly i.e. cartridge.

17. A valve controlled vacuum assembly as set forth in claim 16 including a top mount disposed between said bladder assembly and said pilot valve for positioning said flexible bladder with respect to said pilot valve.

18. A valve controlled vacuum assembly as set forth in claim 17 wherein said top mount includes a pair of flanges that extend over a portion of said pilot valve to secure said top mount thereto.
